(19) United States
(12) Patent Application Publication
(10) Pub. No.: US 2006/0195695 A1
(43) Pub. Date: Aug. 31, 2006

(54) Techniques for verification of electronic device pairing

(76) Inventor: John Keys, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/067,435

(22) Filed: Feb. 25, 2005

(51) Int. Cl. H04L 9/00; H04K 1/00

(52) U.S. Cl. 713/169; 713/171; 380/270; 713/181

(57) ABSTRACT

Techniques for verification of device pairing.

### TECHNICAL FIELD

Embodiments of the invention relate to wireless device pairing. More particularly, embodiments of the invention relate to techniques for use of visual and/or audible confirmation of wireless device pairing, which may include security considerations.

### BACKGROUND

When a user may wish to establish an association or a pairing of electronic devices, the user may cause one or more of the devices to search for available devices using one or more communications channels, whether wired or wireless. When an available device is identified a pairing procedure may be initiated either manually or automatically. This pairing procedure may include cryptographic components such as, for example, exchange of public security keys.

After exchange of public security keys the user may wish to verify that the correct keys have been exchanged. This is typically accomplished by visual inspection of one or more keys displayed as alphanumeric characters, for example, hexadecimal characters. This visual inspection may be useful in defeating or avoiding “man-in-the-middle attacks” that attempt to obtain unauthorized information. However, because these keys may be large values, visual human inspection may be tedious and/or error prone.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a networked communication environment.

FIG. 2 is a block diagram of one embodiment of an electronic system.

FIG. 3 is a block diagram of one embodiment of a peripheral device.

FIG. 4 is a flow diagram of one embodiment of a technique for verification of a pairing of electronic devices using non-alphanumeric audio and/or visual feedback.

FIG. 5 illustrates one embodiment of combined identifiers.

FIG. 6 is a block diagram of an output configuration to provide audio and/or visual indications of combined identifiers.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

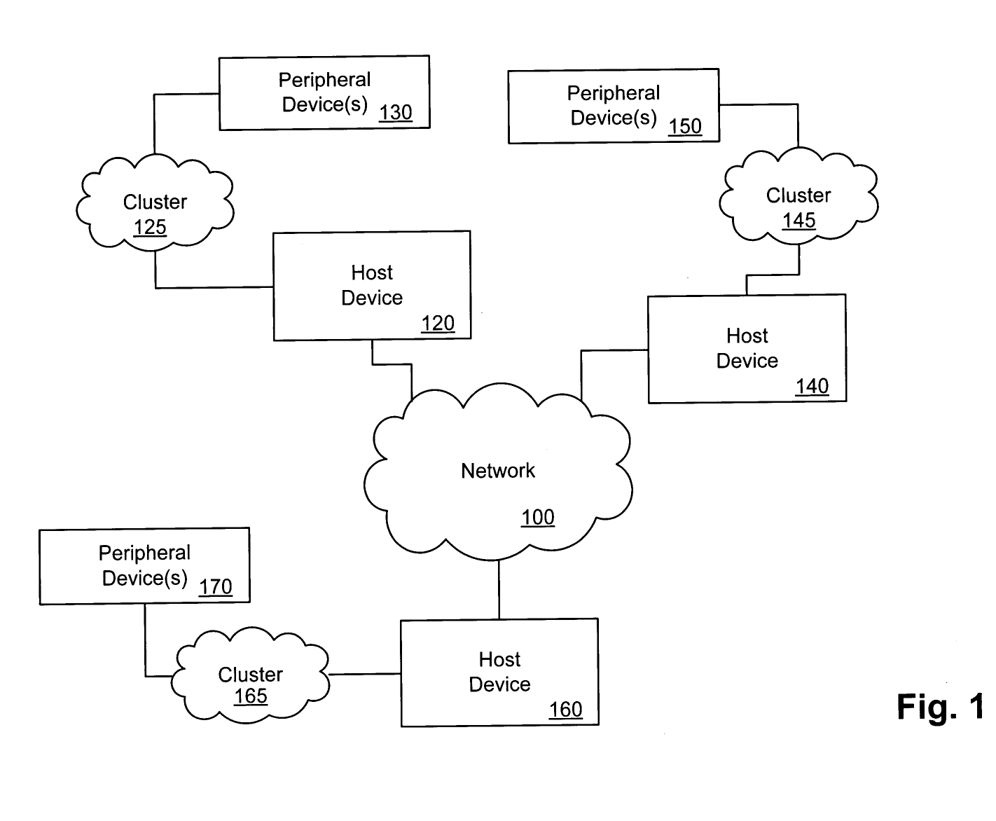

FIG. 1 is a block diagram of one embodiment of a networked communication environment. Network 100 may interconnect any number of electronic devices including host device 120, host device 140 and host device 160. Network 100 may operate using any protocol known in the art whether wired or wireless or a combination thereof.

Host device 120, host device 140 and host device 160 may be any type of electronic device known in the art, for example, a computer system whether desktop or mobile, a personal digital assistant (PDA), an audio/visual system, a cellular telephone, an automobile, etc. In one embodiment, each of host device 120, host device 140 and host device 160 may be coupled with a respective cluster (i.e., cluster 125, cluster 145, cluster 165).

Each cluster may include one or more peripheral devices that may communicate with the respective host devices. For reasons of simplicity of description each cluster is illustrated with a single peripheral device (i.e., peripheral device 130 with cluster 125, peripheral device 150 with cluster 145, peripheral device 170 with cluster 165); however, any number of peripheral devices may be included in a single cluster.

Each cluster may communicate using wired and/or wireless protocols. For example, a wired cluster may communicate using a Universal Serial Bus (USB) protocol, one embodiment of which is described in Universal Serial Bus Revision 2.0, published October, 2000. As another example, a wireless cluster may communicate using a Wireless USB (WUSB) protocol. Details of WUSB protocols may be available, for example, from the Wireless USB Promoter Group. Other wireless protocols may also be used, for example, Multiband OFDM, Ultra-Wideband, etc.

As described in greater detail below, a peripheral device of a cluster may be paired with a host device of the same cluster. During the pairing process, the host device and the peripheral device may exchange identifiers and/or other information (e.g., device identifiers, cryptographic/security keys) that a user may wish to verify to authorize the pairing. In one embodiment, the user may verify the exchange of identifiers and/or other information via feedback provided by the paired devices using non-alphanumeric audio/visual outputs, for example, flashing lights, tones generated by a speaker, vibration, etc.

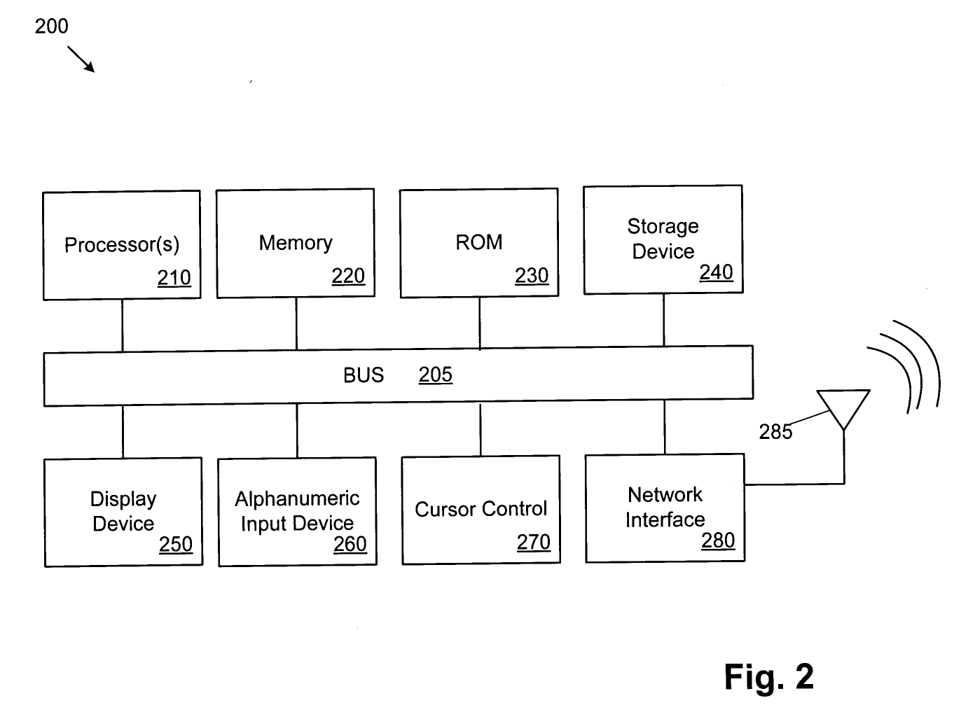

FIG. 2 is a block diagram of one embodiment of an electronic system. The electronic system illustrated in FIG. 2 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components. The electronic system of FIG. 2 typically represents a host system because peripheral devices typically include fewer components and provide reduced functionality as compared to the host system. However, in some embodiments, the peripheral devices may include some or even all of the components of the electronic system illustrated in FIG. 2.

Electronic system 200 includes bus 205 or other communication device to communicate information, and processor 210 coupled to bus 205 that may process information. While electronic system 200 is illustrated with a single processor, electronic system 200 may include multiple processors and/or co-processors. Electronic system 200 further may include random access memory (RAM) or other dynamic storage device 220 (referred to as main memory), coupled to bus 205 and may store information and instructions that may be executed by processor 210. Main memory 220 may also be used to store temporary variables or other intermediate information during execution of instructions by processor 210.

Electronic system 200 may also include read only memory (ROM) and/or other static storage device 230 coupled to bus 205 that may store static information and instructions for processor 210. Data storage device 240 may be coupled to bus 205 to store information and instructions. Data storage device 240 such as a magnetic disk or optical disc and corresponding drive may be coupled to electronic system 200.

Electronic system 200 may also be coupled via bus 205 to display device 250, such as a cathode ray tube (CRT) or liquid crystal display (LCD), to display information to a user. Alphanumeric input device 260, including alphanumeric and other keys, may be coupled to bus 205 to communicate information and command selections to processor 210. Another type of user input device is cursor control 270, such as a mouse, a trackball, or cursor direction keys to communicate direction information and command selections to processor 210 and to control cursor movement on display 250.

Electronic system 200 further may include network interface(s) 280 to provide access to a network, such as a local area network. Network interface(s) 280 may include, for example, a wireless network interface having antenna 285, which may represent one or more antenna(e).

In one embodiment, network interface(s) 280 may provide access to a local area network, for example, by conforming to IEEE 802.11b and/or IEEE 802.11g standards, and/or the wireless network interface may provide access to a personal area network, for example, by conforming to Bluetooth standards or a WUSB protocol. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 280 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

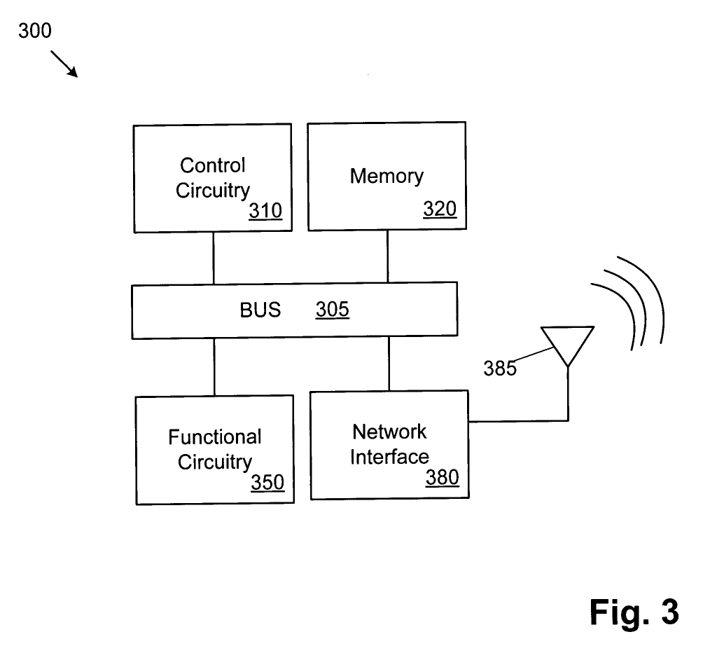

FIG. 3 is a block diagram of one embodiment of a peripheral device. The peripheral device of FIG. 3 is intended to represent a broad category of devices that may be paired with a host device. Therefore, in alternate embodiments, peripheral device 300 may include additional and/or different components.

In one embodiment, peripheral device 300 includes control circuitry 310 coupled with bus 305. Control circuitry 300 may operate to control the functionality and/or operation of peripheral device 300. Memory 320 may also be coupled with bus 305 and may include multiple types of memory including, for example, static random access memory, flash memory, read-only memory, dynamic random access memory, optical memory devices, holographic memory devices, etc.

Network interface 380 may be any type of network interface whether wired or wireless that may support communication with a remote host device. For a wireless network interface, antenna(e) 385 may provide wireless communication functionality in any manner known in the art. Functional circuitry 350 may provide any additional functionality for peripheral device 300.

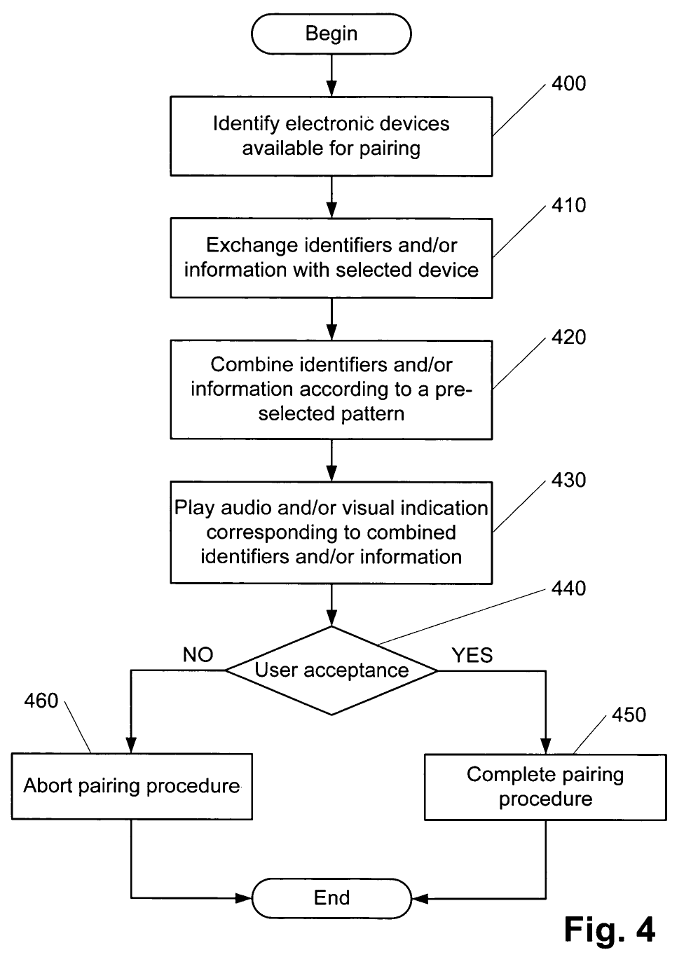

FIG. 4 is a flow diagram of one embodiment of a technique for verification of a pairing of electronic devices using non-alphanumeric audio and/or visual feedback. A host electronic system may perform a search sequence to identify electronic devices available for pairing, 400. The search sequence may be, for example, an identification of all devices coupled with a wired bus (e.g., USB) or an identification of devices that are within range using a wireless protocol (e.g., WUSB, IEEE 802.11).

Upon identification of available devices, the host electronic device may initiate a pairing procedure with a selected device. The pairing procedure may include exchange of identifiers and/or other information, 410. The identifiers exchanged may be, for example, public security keys, device identifiers, or any other type of identifier. In one embodiment, the host electronic device and the peripheral electronic device may exchange public security keys using a wireless communication protocol.

In response to exchanging identifiers, the host electronic device and the peripheral electronic device may combine the identifiers according to a predetermined pattern. The predetermined pattern may be, for example, an interleaving of bytes or other chunks of the keys, a concatenation of the two keys, or any other type of combination as long and the host electronic device and the peripheral electronic device produce the same sequence of bits as a result of the combination.

In one embodiment, after combination of the identifiers, each electronic device may perform a hashing function on the combined identifiers. The hashing function may serve to shorten the resulting combination while retaining an acceptable level of security. Any type of hashing function known in the art may be used.

In one embodiment, the host electronic device and the peripheral electronic device play back non-alphanumeric audio and/or visual indications corresponding to the combined identifiers, 430. The non-alphanumeric audio and/or visual indications may be, for example, audio tones (e.g., the host electronic system and the peripheral electronic system may play the same tone or a different tone), visual indicators (e.g., a flashing LED), a tactile indication (e.g., a buzzing, a vibration), or any combination thereof. In one embodiment, the playback of the indications by the host electronic device and the peripheral electronic device may be synchronized.

The user may monitor the audio and/or visual indications to determine whether the pairing operation was successful. For example, when the audio and/or visual indications are synchronized the corresponding combined identifiers match, which may indicate a successful exchange of keys.

When the user is satisfied that the pairing is successful, the user may provide an input indicating acceptance of the pairing operation, 440. The acceptance may be indicated, for example, by pressing a button or other user input. The user may also indicate absence of acceptance by providing a specific input or by doing nothing, 440.

In one embodiment, if the user accepts the pairing, 440, the paring procedure may be completed, 450. If the user does not accept the pairing, 440, the pairing procedure may be aborted, 460.

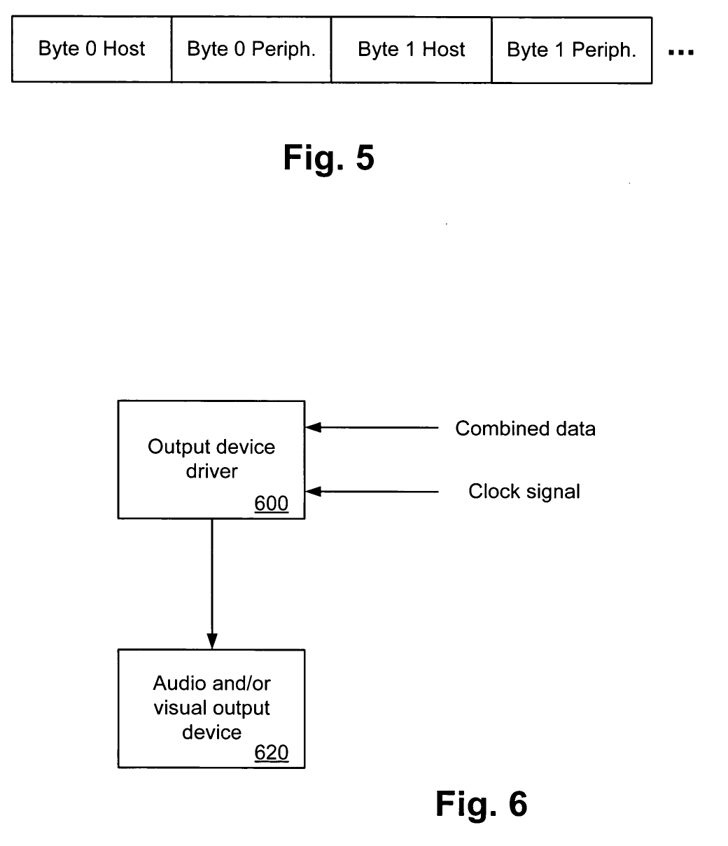

FIG. 5 illustrates one embodiment of combined identifiers. The example of FIG. 5 illustrates interleaved bytes from the host electronic device identifier (e.g., security key) and the peripheral electronic device identifier (e.g., security key). The example of FIG. 5 is but one example of the many combinations that may be made with identifiers from the host electronic device and the peripheral electronic device.

FIG. 6 is a block diagram of an output configuration to provide audio and/or visual indications of combined identifiers. In one embodiment, the combined identifier bit stream and a clock signal are provided as input signals to output device driver 600. Output device driver 600 may be coupled with audio and/or visual output device 610, which may be, for example, a speaker, a LED or any other type of device that may provide non-alphanumeric audio and/or visual signals.

In one embodiment, output device driver 600 causes output device 610 to provide an output that corresponds to the combined identifier bit stream. In one embodiment, a LED may be turned on for a logical value of “1” and off for a logical value of “0” in the bit stream. Similarly, a speaker may provide a first tone for a logical value of “1” and a second tone for a logical value of “0” in the bit stream. Other output variations may also be supported.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
pairing two electronic devices by exchanging identifiers between the two electronic devices;
combining the identifiers according to a pre-selected pattern;
generating a non-alphanumeric indication corresponding to the combined identifiers.

2. The method of claim 1 further comprising causing the two electronic devices to initiate and to play the respective non-alphanumeric indications in a synchronized manner.

3. The method of claim 1 wherein the non-alphanumeric indication comprises a visual indicator.

4. The method of claim 1 wherein the non-alphanumeric indication comprises an audio indicator.

5. The method of claim 1 wherein the exchanged identifiers comprise public security keys.

6. The method of claim 1 wherein the identifiers are exchanged using a wireless protocol.

7. The method of claim 1 wherein combining the indicators according to the pre-selected pattern comprises:
interleaving groups of one or more bits from the respective identifiers; and
performing a hash operation on the interleaved identifiers.

8. An article comprising a computer-readable medium having stored thereon instructions that, when executed, cause one or more processors to:
initiate a pairing procedure between two electronic devices including exchanging identifiers between the two electronic devices;
combine the identifiers according to a pre-selected pattern;
generate a non-alphanumeric indication corresponding to the combined identifiers.

9. The article of claim 8 further comprising instructions that, when executed, cause the one or more processors to cause the two electronic devices to initiate and to play the respective non-alphanumeric indications in a synchronized manner.

10. The article of claim 8 wherein the non-alphanumeric indication comprises a visual indicator.

11. The article of claim 8 wherein the non-alphanumeric indication comprises an audio indicator.

12. The article of claim 8 wherein the exchanged identifiers comprise public security keys.

13. The article of claim 8 wherein the identifiers are exchanged using a wireless protocol.

14. The article of claim 8 wherein the instructions that cause the one or more processors to combine the indicators according to the pre-selected pattern comprise instructions that, when executed, cause the one or more processors to:
interleave groups of one or more bits from the respective identifiers; and
perform a hash operation on the interleaved identifiers.

15. An apparatus comprising:
a device interface;
an output device to provide non-alphanumeric indications;
a processor coupled with the device interface and with the output device, the processor to cause a host electronic device to exchange identifiers with a remote electronic device via the device interface, to combine the exchanged identifiers according to a pre-selected pattern, to generate an indication of the combined identifiers and to cause the indication to be played by the output device.

16. The apparatus of claim 15 wherein the non-alphanumeric indication comprises a visual indicator.

17. The apparatus of claim 15 wherein the non-alphanumeric indication comprises an audio indicator and the output device comprises a speaker.

18. The apparatus of claim 15 wherein the exchanged identifiers comprise public security keys.

19. The apparatus of claim 15 wherein the identifiers are exchanged using a wireless protocol and the device interface comprises a wireless device interface.

20. A system comprising:
a wireless device interface having a substantially omni-directional antenna;
an output device to provide non-alphanumeric indications;
a processor coupled with the wireless device interface and with the output device, the processor to cause a host electronic device to exchange identifiers with a remote electronic device via the device interface, to combine the exchanged identifiers according to a pre-selected pattern, to generate an indication of the combined identifiers and to cause the indication to be played by the output device.

21. The system of claim 20 wherein the non-alphanumeric indication comprises a visual indicator.

22. The system of claim 20 wherein the non-alphanumeric indication comprises an audio indicator and the output device comprises a speaker.

23. The system of claim 20 wherein the exchanged identifiers comprise public security keys.

24. The system of claim 20 wherein the identifiers are exchanged using a wireless protocol and the device interface comprises a wireless device interface.
